(19) United States
(12) Patent Application Publication
(10) Pub. No.: US 2009/0197160 A1
(43) Pub. Date: Aug. 6, 2009

(54) STACK TYPE BATTERY

(75) Inventors: Masayuki FUJIWARA, Kobe-shi (JP); Atsuhiro FUNAHASHI, Toyonaka (JP); Hitoshi MAEDA, Kobe-shi (JP); Yoshitaka SHINYASHIKI, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/364,146

(22) Filed: Feb. 2, 2009

(30) Foreign Application Priority Data
Jan. 31, 2008 (JP) 2008-021652
Mar. 31, 2008 (JP) 2008-092427

(51) Int. Cl. H01M 2/18; H01M 2/02; H01M 2/14

(52) U.S. Cl. 429/146; 429/179; 429/129

(57) ABSTRACT

A stack type battery has a stacked electrode assembly (10) disposed in a reduced pressure condition in an accommodating space within a square-shaped laminate battery case (25) formed by melt-bonding peripheral edges of two laminate films (28) to each other. A positive electrode current collector terminal (15) is joined to positive electrode current collector tabs (11) being overlapped with each other, and a negative electrode current collector terminal (16) is joined to the negative electrode current collector tabs (12) being overlapped with each other. An insulative spacer (30) for compressing welded portions (36) between the positive and negative electrode current collector tabs (11, 12) and the positive and negative electrode current collector terminals (15, 16) is disposed in a tab-connecting space existing between the stacked electrode assembly (10) and an inner face of the laminate battery case (25) from which the positive and negative electrode current collector terminals (15, 16) protrude. An inward displacement restricting protrusion (31) for restricting inward displacement of the positive and negative electrode current collector terminals (15, 16) is provided at a location of the spacer (30) that corresponds to a region between the positive and negative electrode current collector terminals (15, 16).

### BACKGROUND OF THE INVENTION

1. Field of the Invention

The present invention relates to stack type batteries used for, for example, robots, electric vehicles, and backup power sources. More particularly, the invention relates to stack type batteries that can improve charge-discharge characteristics at high rate.

2. Description of Related Art

In recent years, batteries have been used for not only the power source of mobile information terminal devices such as mobile-phones, notebook computers, and PDAs but also for such applications as robots, electric vehicles, and backup power sources. This has led to a demand for higher capacity batteries. Because of their high energy density and high capacity, lithium ion batteries are widely utilized as the power sources for such applications as described above.

The battery configurations of lithium ion batteries are broadly grouped into two types: cylindrical type, in which a spirally wound electrode assembly is enclosed in a closed-end cylindrical battery case, and stack type, in which a flat-shaped spirally wound electrode assembly or a stacked electrode assembly comprising a plurality of stacks of rectangular-shaped electrodes is enclosed in a closed-end prismatic battery case or in a laminate battery case prepared by welding two laminate films together or welding the peripheral portions of a folded laminate film together.

Of the above-described lithium ion batteries, the stack type battery enclosed in a laminate battery case has a stacked electrode assembly as follows. A required number of sheet-shaped positive electrode plates each having a positive electrode current collector tab and a required number of sheet-shaped negative electrode plates each having a negative electrode current collector tab are stacked with a separator interposed between each of the electrodes. The plurality of positive electrode current collector tabs are overlapped with each other and welded to a positive electrode current collector terminal, while the plurality of negative electrode current collector tabs are likewise overlapped with each other and welded to a negative electrode current collector terminal. The positive and negative electrode current collector terminals protrude from the laminate battery case.

The battery having the just-described structure, however, has the following problems.

(1) The stacked electrode assembly therein cannot be fixed in position since the laminate film that forms the laminate battery case is pliant. As a consequence, the stacked electrode assembly may sway in the laminate battery case, or misalignment of the stacked electrode assembly may occur, when, for example, the mobile electronic device incorporating this battery is under repeated vibrations.

In such conditions, various problems arise as follows. Mechanically weak portions, such as the welded part between the positive electrode current collector tabs and the positive electrode current collector terminal and the welded part between the negative electrode current collector tabs and the negative electrode current collector terminal, undergo bending repeatedly, causing deformation and disconnection. Pointed corner portions or burrs of the stacked electrode assembly may pierce the laminate battery case, damaging the laminate battery case. The stacked electrode assembly may be brought into contact with the metal layer inside the laminate battery case, so a gas can be generated because of the electrolyte solution around the contact portion. The positive and negative electrode plates may be brought into contact with the respective counter electrodes, causing internal short circuits.

In view of such problems, a battery in which a pair of protective parts are provided in a space within a laminate battery case, and positive and negative electrode current collector tabs are disposed in a space formed between the protective parts has been proposed, in order to prevent the stacked electrode assembly from moving in the laminate battery case (see International Publication No. WO 00/59063).

The structure disclosed in the just-mentioned publication may prevent mechanically weak parts, such as the joined portions between the positive and negative electrode current collector terminals and the positive and negative electrode current collector tabs, from direct impact force. However, the structure does not directly protect the joined portions between the positive and negative electrode current collector terminals and the positive and negative electrode current collector tabs. Consequently, if the stacked electrode assembly sways in the laminate battery case or misalignment of the stacked electrode assembly occurs, deformation or disconnection can occur in mechanically weak parts, such as the welded parts between the positive and negative electrode current collector terminals and the positive and negative electrode current collector tabs. It should be noted that although the just-mentioned publication suggests that the stacked electrode assembly can be inhibiting from swaying in the laminate battery case, it is difficult to prevent such swaying completely, especially when the stacked electrode assembly is used as a power source for robots and electric vehicles, which are under mechanical stress such as vibrations in use.

In addition, the above-mentioned publication shows, in FIG. 24, a structure in which a pair of flat-shaped spacer members are bonded to each other so as to undergo elastic deformation so that the positive and negative electrode terminals (including the welded parts with the positive and negative electrode current collector tabs) are sandwiched between the spacers, to cover the positive and negative electrode terminals, whereby the stacked electrode assembly can be fixed so that it can barely move. However, when the welded parts between the positive and negative electrode current collector terminals and the positive and negative electrode current collector tabs and so forth are pressed merely by the elastic force, the pressing force may not be enough to inhibit the shift (or deformation) of the positive and negative electrode current collector terminals sufficiently. As a consequence, deformation or disconnection of the positive and negative electrode current collector tabs may occur in the joined portions between the positive and negative electrode current collector terminals and the positive and negative electrode current collector tabs.

(2) For the battery having the above-described structure, positioning of the positive electrode current collector tabs with the positive electrode current collector terminal and positioning of the negative electrode current collector tab with the negative electrode current collector terminal are determined visually when welding the positive electrode current collector tabs with the positive electrode current collector terminal and the negative electrode current collector tabs with the negative electrode current collector terminal. The relative position between the positive electrode current collector tabs and the positive electrode current collector terminal and the relative position between the negative electrode current collector tabs and the negative electrode current collector terminal inevitably vary from one battery to another, so the positions at which the positive and negative electrode current collector terminals protrude from the laminate battery case and the distance between the positive and negative electrode current collector terminals are different from one battery to another. Consequently, when a battery module is made using a multiplicity of batteries, electrical connection between the current collector terminals cannot be made smoothly, resulting in poor reliability and low productivity.

Another conventional technique that has been proposed is as follows. Projecting pieces are placed around stacked current collector tabs, and a plurality of current collector tabs are simultaneously bound together. A welding electrode is applied via the projecting pieces so that the current collector tabs are welded to each other integrally and also the current collector tabs are welded to the projecting pieces integrally (see Japanese Published Unexamined Patent Application No. 8-167408).

This technique is, however, intended merely to join the current collector tabs integrally, and it is not intended to facilitate the positioning between the current collector tabs and the current collector terminals.

### BRIEF SUMMARY OF THE INVENTION

In view of the foregoing problems, it is an object of the present invention to provide a stack type battery that can dramatically improve the reliability by inhibiting deformation and disconnection in the joined portions between the positive and negative electrode current collector terminals and the positive and negative electrode current collector tabs even when the stacked electrode assembly sways or moves in the laminate battery case.

It is also an object of the present invention to provide a stack type battery that achieves improvements in reliability and productivity by enabling smooth electrical connecting between the current collector terminals when a battery module is made using a multiplicity of batteries.

In order to accomplish the foregoing and other objects, the present invention provides a stack type battery comprising: a stacked electrode assembly comprising a plurality of positive electrode plates having respective positive electrode current collector tabs extending outwardly therefrom, a plurality of negative electrode plates having respective negative electrode current collector tabs extending outwardly therefrom, and separators, the positive electrode plates and the negative electrode plates being alternately stacked one upon the other with the separators interposed therebetween; a square-shaped laminate battery case, for enclosing the stacked electrode assembly and an electrolyte solution in an accommodating space therein, being formed by welding peripheral edges of one or more laminate films each comprising a metal layer and a plastic layer; a positive electrode current collector terminal joined to the positive electrode current collector tabs being overlapped with each other and a negative electrode current collector terminal joined to the negative electrode current collector tabs being overlapped with each other, the positive and negative electrode current collector terminals protruding from one side of the laminate battery case in a separated manner with respect to its center line; and at least one insulative spacer, for compressing respective joined portions between the positive and negative electrode current collector tabs and the positive and negative electrode current collector terminals, the at least one insulative spacer being disposed in a tab-connecting space, the tab-connecting space being between an inner face of the laminate battery case through which the positive and negative electrode current collector terminals protrude and a face of the stacked electrode assembly from which the positive and negative electrode current collector tabs protrude, and having an inward displacement restricting protrusion, for restricting inward displacement of the positive and negative electrode current collector terminals, being provided at a location of the spacer corresponding to a region between the positive and negative electrode current collector terminals.

When the insulative spacer for compressing the joined portions between the positive and negative electrode current collector tabs and the positive and negative electrode current collector terminals is provided as the above-described configuration, the joined portions between the positive and negative electrode current collector terminals and the positive and negative electrode current collector tabs are protected directly. Therefore, deformation and disconnection in the joined portions between the positive and negative electrode current collector terminals and the positive and negative electrode current collector tabs are inhibited even when the stacked electrode assembly sways in the laminate battery case or when misalignment of the stacked electrode assembly occurs. It should be noted that the spacer should be insulative in order to prevent short circuiting in the battery by the spacer.

In addition, provision of the inward displacement restricting protrusion at a location of the spacer corresponding to a region between the positive and negative electrode current collector terminals makes it possible to inhibit inward displacement (deformation) of the positive and negative electrode current collector terminals more reliably and therefore inhibit deformation and disconnection of the positive and negative electrode current collector tabs that result from the inward displacement of the positive and negative electrode current collector terminals.

It is desirable that the spacer have a shape such that it fills up the tab-connecting space excluding a region in which the positive and negative electrode current collector tabs are overlapped.

When the spacer has a shape such that it fills up the tab-connecting space excluding a region in which the positive and negative electrode current collector tabs are overlapped, the free space in the battery is minimized. Therefore, displacement of the stacked electrode assembly can be prevented, and at the same time, the laminate can be prevented from creasing when sealing the battery in a reduced pressure condition. Moreover, the spacer and the positive and negative electrode current collector tabs make contact with each other at regions other than the joined portions between the positive and negative electrode current collector tabs and the positive and negative electrode current collector terminals. As a result, the positive and negative electrode current collector tabs are prevented from being deformed or disconnected also at regions other than the welded portions.

It is desirable that the spacer be made of a material that is resistant to the electrolyte solution and is capable of reserving the electrolyte solution.

In order to increase the capacity of the stack type battery, it is generally necessary to increase the electrode area or increase the number of the stacks. However, when such techniques are employed and the battery is charged and discharged at high rates, problems arise that the battery capacity lowers during discharge and the cycle life becomes shorter. One of the causes for this is the electrolyte solution shortage in the battery.

When the spacer is made of a material capable of reserving an electrolyte solution as described above, the problem of the electrolyte amount shortage in the battery is lessened significantly. Therefore, the battery capacity loss and the cycle performance degradation during discharge can be lessened even when the capacity of the battery is increased and the battery is charged and discharged at high rates.

When the spacer itself is made of a material capable of reserving an electrolyte solution, there is an advantage that the preparation of the spacer is easy because it is unnecessary to use two separate components, as will be described later, an outer shell portion and an electrolyte reserving portion disposed inside the outer shell portion (only one component is needed).

It is desirable that the spacer have an outer shell portion and an electrolyte reserving portion disposed in the outer shell portion, the outer shell portion being made of a material that is resistant to the electrolyte solution while the electrolyte reserving portion being made of a material that is resistant to the electrolyte solution and is capable of reserving the electrolyte solution, and the outer shell portion having an electrolyte supply port for supplying the electrolyte solution reserved in the electrolyte reserving portion to the stacked electrode assembly.

The spacer should have a certain degree of hardness because the spacer needs to compress the joint portions. A material that is capable of reserving an electrolyte solution and also has a certain degree of hardness is very limited, such as a porous sintered material of ceramic and the like. In view of this, when the spacer has an outer shell portion and an electrolyte reserving portion disposed in the outer shell portion, it is sufficient that the outer shell portion should be a material having a certain degree of hardness and electrolyte resistant property (in other words, it does not need to reserve the electrolyte solution), and it is sufficient that the electrolyte reserving portion should be made of a material that has electrolyte resistant property and is capable of reserving the electrolyte solution (i.e., it does not need to have a certain degree of hardness, and it may be made of a material such as sponge). As a result, there are more choices in selecting the material, and the manufacturing cost of the spacer can be reduced.

It is desirable that the electrolyte supply port be provided in a direction toward the stacked electrode assembly.

When the electrolyte supply port is provided in a direction toward the stacked electrode assembly, the electrolyte solution may be supplied to the electrode assembly body more smoothly.

It is desirable that: the one or more laminate films comprise two laminate films, each of the laminate films having an accommodating recessed portion that constitutes the accommodating space; the positive electrode current collector tabs and the positive electrode current collector terminal be joined to each other with the positive electrode current collector tabs being overlapped on both sides of the positive electrode current collector terminal while the negative electrode current collector tabs and the negative electrode current collector terminal are joined to each other with the negative electrode current collector tabs being overlapped on both sides of the negative electrode current collector terminal; and the at least one insulative spacer comprise two insulative spacers disposed in respective tab-connecting spaces existing between the laminate battery case and the positive and negative electrode current collector tabs.

When the spacers are provided in the respective tab-connecting spaces existing between the positive and negative electrode current collector tabs and the laminate battery case, the pressure applied to the joint portions between the positive and negative electrode current collector tabs and the positive and negative electrode current collector terminals increases, so the foregoing advantageous effects can be exhibited further.

It is desirable that one of the spacers have a first positioning protrusion and the other one of the spacers have a first positioning hole.

When one of the spacers has a first positioning protrusion while the other one of the spacers has a first positioning hole, positioning between the two spacers with each other can be made easily when manufacturing the stack type battery.

It is desirable that the one or more laminate films comprise two laminate films, only one of the laminate films having an accommodating recessed portion that constitutes the accommodating space; the positive electrode current collector tabs and the positive electrode current collector terminal be joined to each other with the positive electrode current collector tabs being overlapped on only one side of the positive electrode current collector terminal while the negative electrode current collector tabs and the negative electrode current collector terminal be joined to each other with the negative electrode current collector tabs being overlapped on only one side of the negative electrode current collector terminal; and the spacer be disposed only in the tab-connecting space existing between the laminate battery case and the positive and negative electrode current collector tabs.

With the above-described configuration, only one spacer is necessary. Therefore, the manufacturing cost of the battery can be reduced.

It is desirable that the stacked electrode assembly have a thickness of 5 mm or greater with respect to its stacking direction.

When the stacked electrode assembly has a thickness of 5 mm or greater with respect to its stacking direction, misalignment of the stacked battery assembly tends to occur easily, and therefore, the advantageous effects of the invention will be more significant.

It is desirable that a positive electrode active material of the positive electrode plates and a negative electrode active material of the negative electrode plates comprise a material capable of intercalating and deintercalating lithium.

When the invention is applied to a lithium-ion battery in which the positive electrode active material and the negative electrode active material are made of a material capable of intercalating and deintercalating lithium, the capacity of the battery can be increased while improving the reliability of the battery.

It is desirable that the spacer have substantially the same length as the dimension of the width of the stacked electrode assembly; both ends of the spacer exist at substantially the same locations as both side faces of the stacked electrode assembly; the positive and negative electrode current collector terminals have second positioning holes respectively formed therein; and the spacer have second positioning protrusions at locations corresponding to the second positioning holes.

When the spacer disposed in the tab-connecting space existing between the inner face of the laminate battery case and the face of the stacked electrode assembly from which the positive and negative electrode current collector tabs protrude has substantially the same dimension as the width of the stacked electrode assembly and both ends of the spacer are at substantially the same positions as both sides of the stacked electrode assembly, the relative position of the spacer and the stacked electrode assembly is determined. Accordingly, the relative position between the spacer and the positive electrode current collector tabs extending outwardly from a positive electrode that constitutes a part of the stacked electrode assembly is determined, and also, the relative position between the spacer and the negative electrode current collector tabs extending outwardly from a negative electrode that constitutes a part of the stacked electrode assembly is determined. Moreover, the second positioning holes are formed in the positive and negative electrode current collector terminals, while the second positioning protrusions that fit into the holes are formed at locations of the spacer corresponding to the second positioning holes; therefore, the relative position between the positive electrode current collector terminal and the spacer as well as the relative position between the negative electrode current collector terminal and the spacer is determined. Thus, the relative positions between the positive electrode current collector tab and the positive electrode current collector terminal, and the relative positions between the negative electrode current collector tabs and the negative electrode current collector terminal are determined via the spacers. This serves to suppress variations among batteries in the locations at the laminate battery case from which the positive and negative electrode current collector terminals protrude and in the distance between the positive and negative electrode current collector terminals. Therefore, when a battery module is made using a multiplicity of batteries, electrical connection can be made smoothly between the current collector terminals. As a result, the reliability and productivity of the battery module can be prevented from degrading.

It is desirable that the spacer have an outward displacement restricting protrusion, for restricting outward displacement of the positive and negative electrode current collector terminals, being provided at a further outward position than a contact position of the spacer and the positive and negative electrode current collector terminals.

Shifting of the positive and negative electrode current collector terminals can be prevented more reliably for the same reason as in the case of the inward displacement restricting protrusion, and at the same time, the workability for fitting the second positioning protrusions into the second positioning holes improves.

It is desirable that: the positive electrode current collector tabs and the positive electrode current collector terminal be joined to each other with the positive electrode current collector tabs being overlapped on both sides of the positive electrode current collector terminal while the negative electrode current collector tabs and the negative electrode current collector terminal be joined to each other with the negative electrode current collector tabs being overlapped on both sides of the negative electrode current collector terminal; the at least one insulative spacer comprise two insulative spacers disposed in respective tab-connecting spaces existing between the laminate battery case and the positive and negative electrode current collector tabs; one of the spacers have the second positioning protrusion, and the other one of the spacers have a third positioning hole in which the second positioning protrusion fits.

When the positive and negative electrode current collector terminals are sandwiched by the two insulative spacers, the positive and negative electrode current collector terminals can be fixed more reliably. Moreover, positioning of the spacers with each other can also be made more reliably when the one of the spacers has the second positioning protrusion and the other one of the spacers has a third positioning hole in which the second positioning protrusion fits. It should be noted that the third positioning hole has the same advantageous effect as that of the first positioning hole (the same advantageous effect of facilitating positioning of the spacers with each other), and in addition, the relative positions of the other one of the spacers and the positive and negative electrode current collector tabs are determined via the one of the spacers.

It is desirable that the positive electrode current collector tabs and the positive electrode current collector terminal be joined to each other with the positive electrode current collector tabs being overlapped on only one side of the positive electrode current collector terminal while the negative electrode current collector tabs and the negative electrode current collector terminal be joined to each other with the negative electrode current collector tabs being overlapped on only one side of the negative electrode current collector terminal; and the spacer be disposed only in the tab-connecting space existing between the laminate battery case and the positive and negative electrode current collector tabs.

With the above-described configuration, only one spacer is necessary. Therefore, the manufacturing cost of the battery can be reduced.

In order to accomplish the foregoing and other objects, the present invention also provides a stack type battery comprising: a stacked electrode assembly comprising a plurality of positive electrode plates having respective positive electrode current collector tabs extending outwardly therefrom, a plurality of negative electrode plates having respective negative electrode current collector tabs extending outwardly therefrom, and separators, the positive electrode plates and the negative electrode plates being alternately stacked one upon the other with the separators interposed therebetween; a square-shaped laminate battery case, for enclosing the stacked electrode assembly and an electrolyte solution in an accommodating space therein, being formed by welding peripheral edges of one or more laminate films each comprising a metal layer and a plastic layer; a positive electrode current collector terminal joined to the positive electrode current collector tabs being overlapped with each other and a negative electrode current collector terminal joined to the negative electrode current collector tabs being overlapped with each other, the positive and negative electrode current collector terminals protruding from one side of the laminate battery case in a separated manner with respect to its center line; and at least one spacer being disposed in a tab-connecting space, the tab-connecting space being between an inner face of the laminate battery case through which the positive and negative electrode current collector terminals protrude and a face of the stacked electrode assembly from which the positive and negative electrode current collector tabs protrude, the at least one insulative spacer having substantially the same length as the dimension of the width of the stacked electrode assembly and both ends of the spacer existing at substantially the same locations as both side faces of the stacked electrode assembly; and the positive and negative electrode current collector terminals having second positioning holes respectively formed therein; and the spacer having second positioning protrusions at locations corresponding to the second positioning holes.

It is desirable that the spacer have an inward displacement restricting protrusion, for restricting inward displacement of the positive and negative electrode current collector terminals, being provided at a location of the spacer corresponding to a region between the positive and negative electrode current collector terminals.

Shifting of the positive and negative electrode current collector terminals is prevented by the positioning through holes formed in the positive and negative electrode current collector terminals and the positioning protrusions formed on the spacer. When the inward displacement restricting protrusion is formed at the location of the spacer corresponding to the region between the positive and negative electrode current collector terminals, inward displacement of the positive and negative electrode current collector terminals can be prevented more reliably. Moreover, when the inward displacement restricting protrusion is provided, inward displacement of the positive and negative electrode current collector terminals can be prevented even if the positioning through holes are formed to be slightly larger than the positioning protrusions. As a result, the reliability and productivity degradations of the battery module can be prevented, and at the same time, workability is improved when fitting the positioning protrusions into the positioning through holes.

It is desirable that the spacer have an outward displacement restricting protrusion, for restricting outward displacement of the positive and negative electrode current collector terminals, being provided at a further outward position than a contact position of the spacer and the positive and negative electrode current collector terminals.

It is desirable that: the positive electrode current collector tabs and the positive electrode current collector terminal be joined to each other with the positive electrode current collector tabs being overlapped on both sides of the positive electrode current collector terminal while the negative electrode current collector tabs and the negative electrode current collector terminal be joined to each other with the negative electrode current collector tabs being overlapped on both sides of the negative electrode current collector terminal; the at least one insulative spacer comprise two insulative spacers disposed in respective tab-connecting spaces existing between the laminate battery case and the positive and negative electrode current collector tabs; one of the spacers have the second positioning protrusion, and the other one of the spacers have a second positioning hole in which the second positioning protrusion fits.

It is desirable that the positive electrode current collector tabs and the positive electrode current collector terminal be joined to each other with the positive electrode current collector tabs being overlapped on only one side of the positive electrode current collector terminal while the negative electrode current collector tabs and the negative electrode current collector terminal be joined to each other with the negative electrode current collector tabs being overlapped on only one side of the negative electrode current collector terminal; and the spacer be disposed only in the tab-connecting space existing between the laminate battery case and the positive and negative electrode current collector tabs.

According to the present invention, the joined portions between the positive and negative electrode current collector terminals and the positive and negative electrode current collector tabs are protected directly. Therefore, even when the stacked electrode assembly sways in the laminate battery case or when misalignment of the stacked electrode assembly occurs, deformation and disconnection are inhibited in the joined portions between the positive and negative electrode current collector terminals and the positive and negative electrode current collector tabs. Moreover, electrical connection between the current collector terminals can be made smoothly when a battery module is made using a multiplicity of batteries. As a result, reliability of the stack type battery can be improved dramatically. Moreover, significant advantageous effects are obtained that reliability and productivity of the stack type battery can be improved.

### BRIEF DESCRIPTION OF THE DRAWINGS

FIG. 1 is an exploded perspective view illustrating a stacked electrode assembly used for a stack type battery according to a first embodiment of the present invention;

FIG. 2 is a perspective view illustrating the stack type battery according to the first embodiment;

FIG. 3 illustrates a portion of the stack type battery according to the first embodiment, wherein FIG. 3(a) shows a plan view of the positive electrode, FIG. 3(b) shows a perspective view of the separator, and FIG. 3(c) shows a plan view illustrating a pouch-type separator in which the positive electrode is disposed;

FIG. 4 is a plan view illustrating a negative electrode used for the stack type battery according to the first embodiment;

FIG. 5 is a perspective view illustrating a stacked electrode assembly used for the stack type battery according to the first embodiment;

FIG. 6 is a schematic view illustrating the stack type battery according to the first embodiment, viewed from the front;

FIG. 7 is a cross-sectional view taken along line A-A in FIG. 2;

FIG. 8 is a perspective view illustrating a spacer used for the stack type battery according to the first embodiment;

FIG. 9 illustrates the spacer used for the stack type battery according to the first embodiment, wherein FIG. 9(a) shows a front view thereof, FIG. 9(b) shows a plan view thereof, and FIG. 9(c) shows a side view thereof;

FIG. 10 is a perspective view illustrating the stack type battery according to the first embodiment from which the laminate battery case is removed;

FIG. 11 is an exploded perspective view illustrating the stack type battery according to the first embodiment from which the laminate battery case is removed;

FIG. 12 is a perspective view illustrating a modified example of the spacer used for the stack type battery according to the first embodiment;

FIG. 13 is a perspective view illustrating a modified example of the spacer used for the stack type battery according to the first embodiment;

FIG. 14 is a perspective view illustrating a modified example of the spacer used for the stack type battery according to the first embodiment;

FIG. 15 is a perspective view illustrating a modified example of the spacer used for the stack type battery according to the first embodiment;

FIG. 16 is a perspective view illustrating a modified example of the spacer used for the stack type battery according to the first embodiment;

FIG. 17 is a cross-sectional view illustrating a modified example of the stack type battery according to the first embodiment;

FIG. 18 is a perspective view illustrating a modified example of the spacer used for the stack type battery according to the first embodiment;

FIG. 19 is a schematic view illustrating a stack type battery according to a second embodiment, viewed from the front;

FIG. 20 is a cross-sectional view taken along line A-A in FIG. 19;

FIG. 21 is a perspective view illustrating one of spacers used for the stack type battery according to the second embodiment;

FIG. 22 illustrates the one of the spacers used for the stack type battery according to the second embodiment, wherein FIG. 22(a) shows a front view thereof, FIG. 22(b) shows a plan view thereof, and FIG. 22(c) shows a side view thereof;

FIG. 23 is a perspective view illustrating the other one of the spacers used for the stack type battery according to the second embodiment;

FIG. 24 is a perspective view illustrating a stacked electrode assembly used for the stack type battery according to the second embodiment;

FIG. 25 is a schematic view illustrating a method for manufacturing the stack type battery according to the second embodiment using a stacked electrode assembly manufacturing jig;

FIG. 26 is a schematic view illustrating a method for manufacturing the stack type battery according to the second embodiment using a stacked electrode assembly manufacturing jig;

FIG. 27 is a perspective view illustrating a modified example of the other one of the spacers used for the stack type battery according to the second embodiment;

FIG. 28 is a cross-sectional view illustrating a modified example of the stack type battery according to the second embodiment, taken along the same sectional line as in FIG. 20;

FIG. 29 is a perspective view illustrating a modified example of the one of the spacers used for the stack type battery according to the second embodiment;

FIG. 30 is a schematic view illustrating a method for manufacturing the stack type battery of a modified example according to the second embodiment using a stacked electrode assembly manufacturing jig;

FIG. 31 is a perspective view illustrating a modified example of the one of the spacers used for the stack type battery according to the second embodiment; and

FIG. 32 is a perspective view illustrating a modified example of the one of the spacers used for the stack type battery according to the second embodiment.

### DETAILED DESCRIPTION OF THE INVENTION

### First Embodiment

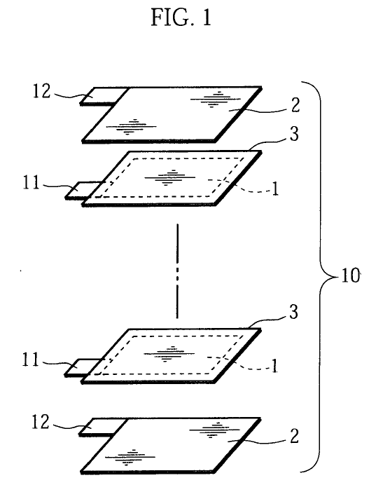

Hereinbelow, a stacked type battery (prismatic lithium ion battery) according to a first embodiment of the present invention will be described with reference to FIGS. 1 through 18. It should be construed, however, that the stack type battery according to this invention is not limited to the following embodiments and examples but various changes and modifications are possible without departing from the scope of the invention. This also applies to the later-described second embodiment.

### Structure of Stack Type Battery

As illustrated in FIG. 1, a stacked type battery comprises a stacked electrode assembly 10. In the stacked electrode assembly 10, a multiplicity of pouch-type separators 3 and a multiplicity of negative electrode plates 2 are stacked on each other. Each of the pouch-type separators 3 is made of two sheets of separator and contains a positive electrode plate 1 therein. The negative electrode plates 2 are also placed at the outermost stacks. Since the negative electrode plates 2 need to be placed at the outermost stacks, the stacked electrode assembly 10 is configured so that the number of the negative electrode plates 2 is greater by one than that of the positive electrode plates 1 (specifically, the stacked electrode assembly 10 contains 50 sheets of positive electrode plate 1 and 51 sheets of negative electrode plate 2).

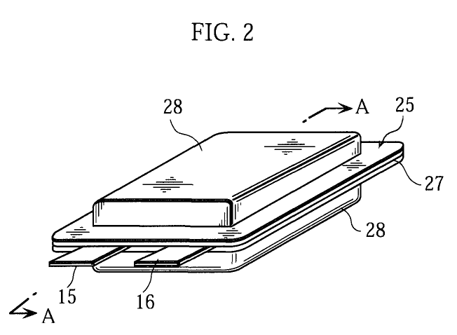

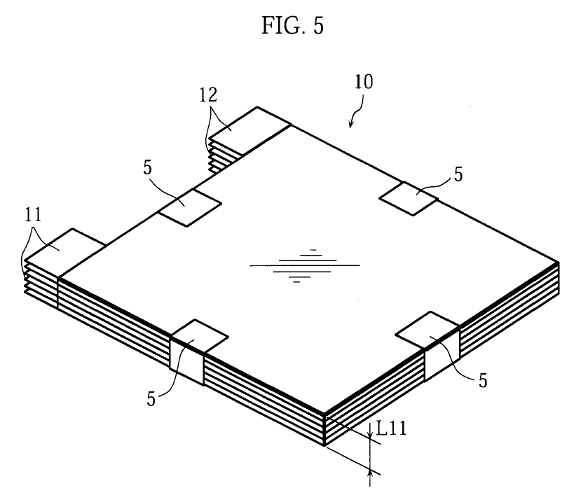

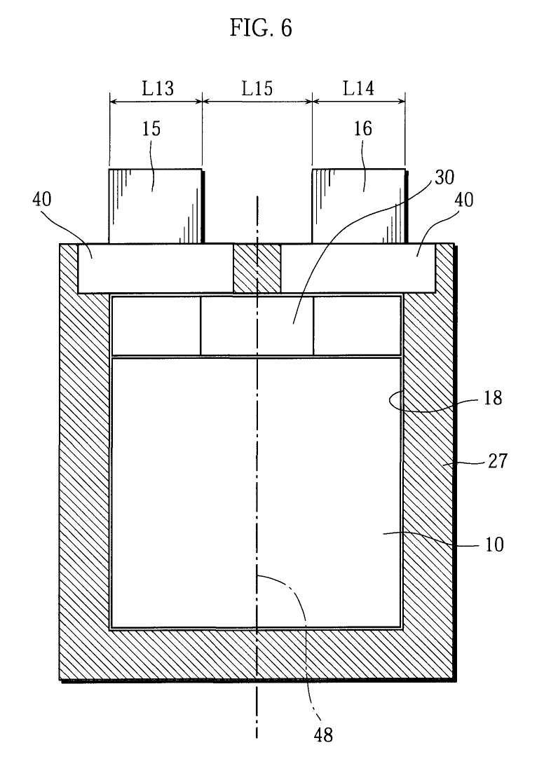

In addition, as illustrated in FIG. 5, tapes 5 for preventing misalignment of the electrode plates 1 and 2 are attached on the stacked electrode assembly 10 (the thickness L11 of the stacked electrode assembly immediately after manufacturing, in other words, before being enclosed in the accommodating space of the laminate battery case is 12 mm) so that they straddle over the stacked electrode assembly 10. The stacked electrode assembly 10 as well as an electrolyte solution is enclosed in an accommodating space within a laminate battery case 25, as shown in FIG. 2, formed by melt-bonding two sheets of laminate film 28. A positive electrode current collector terminal 15 made of an aluminum plate (thickness: 0.5 mm) and a negative electrode current collector terminal 16 made of a copper plate (thickness: 0.5 mm) protrude from the laminate battery case 25. As illustrated in FIG. 6, the positive electrode current collector terminal 15 and the negative electrode current collector terminal 16 are disposed in a separated manner with respect to the center line 48 of the stack type battery (i.e., in such a manner that they are disposed symmetrically with respect to the center line 48, in the case of FIG. 6). The laminate film 28 has a structure in which plastic layers are formed on both sides of an aluminum foil. In FIG. 6, reference numeral 27 represents a melt-bonded portion of the two sheets of laminate film 28.

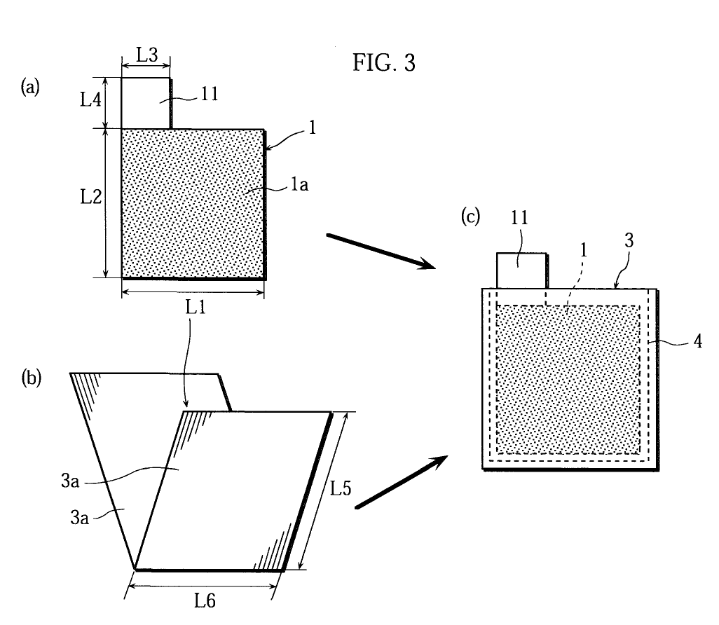

As illustrated in FIG. 3(a), each of the positive electrode plates 1 has a positive electrode active material layer 1a disposed over the entire surfaces of both sides of a positive electrode conductive current collector made of a rectangular-shaped aluminum foil (thickness: 15 μm). The positive electrode active material layer 1a comprises a positive electrode active material made of LiCoO₂, a conductive agent made of carbon black, and a binder agent made of polyvinylidene fluoride. The positive electrode plate 1 has a width L1 of 95 mm and a height L2 of 95 mm. A positive electrode current collector tab 11 (width L3: 30 mm, height L4: 20 mm) protrudes from one side of the positive electrode plate 1. The positive electrode current collector tab 11 is formed integrally with the positive electrode conductive current collector and is not provided with the positive electrode active material layer 1a. A plurality of the positive electrode current collector tabs 11 are welded to the positive electrode current collector terminal 15 in such a manner that they are placed on both sides of the positive electrode current collector terminal 15 (25 sheets of the positive electrode current collector tab 11 are placed on each one side of the positive electrode current collector terminal 15).

The structure of the pouch-type separator 3 is as follows. As illustrated in FIG. 3(c), two separators 3a each made of polypropylene (PP) are overlapped with each other. A melt-bond portion 4 for melt-bonding the separators 3a to each other is provided at the peripheral portion of the separator 3a. Such a structure enables the positive electrode plate 1 to be accommodated in the pouch-type separator 3. Referring to FIG. 3(b), the separator 3a has a square shape with a height L5 of 100 mm and a width L6 of 100 mm, and the thickness is 30 μm.

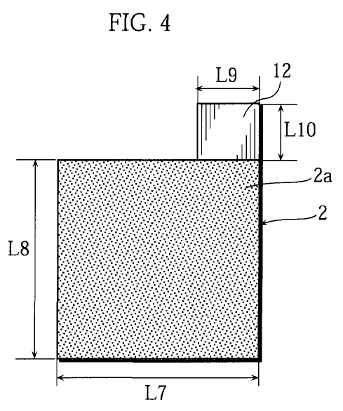

As illustrated in FIG. 4, each of the negative electrode plates 2 has a negative electrode active material layer 2a disposed over the entire surfaces of both sides of a negative electrode conductive current collector made of a rectangular-shaped copper foil (thickness: 10 μm). The negative electrode active material layer 2a comprises a negative electrode active material made of natural graphite and a binder agent made of polyvinylidene fluoride. The negative electrode plate 2 has a width L7 of 100 mm and a height L8 of 100 mm, which is the same dimensions as those of the separator 3a. A negative electrode current collector tab 12 (width L9: 30 mm, height L10: 20 mm) protrudes from one side of the negative electrode plate 2. The negative electrode current collector tab 12 is formed integrally with the negative electrode conductive current collector and is not provided with the negative electrode active material layer 2a. A plurality of the negative electrode current collector tabs 12 are welded to the negative electrode current collector terminal 16 in such a manner that they are placed on both sides of the negative electrode current collector terminal 16 (25 sheets of the negative electrode current collector tab 12 are placed on one side of the negative electrode current collector terminal 16, and 26 sheets of the negative electrode current collector tab 12 are placed on the other side of the negative electrode current collector terminal 16).

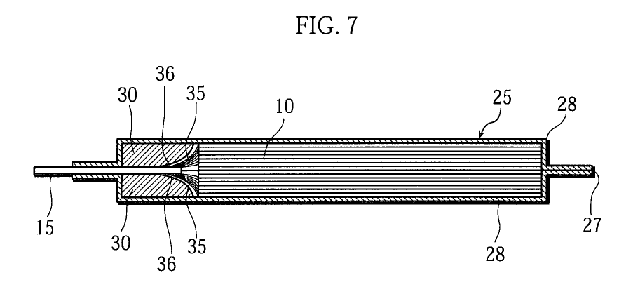

As illustrated in FIGS. 6 and 7, in addition to the stacked electrode assembly 10, two insulative spacers 30 are disposed in an accommodating space 18 within the laminate battery case 25, which is formed by two sheets of the laminate film 28, so that the two spacers sandwich the positive and negative electrode current collector tabs 11 and 12 and the positive and negative electrode current collector terminals 15 and 16. These spacers 30 are composed of a porous sintered material made of ceramic that can retain an electrolyte solution. More specifically, the spacers 30 are disposed in a tab-connecting space existing between the inner face of the laminate battery case 25 through which the positive and negative electrode current collector terminals 15 and 16 protrude and the face of the stacked electrode assembly 10 from which the positive and negative electrode current collector tabs 11 and 12 protrude, the tab-connecting space being a space excluding an overlapped part 35 of the positive and negative electrode current collector tabs 11, 12. (It should be noted that although FIG. 7 depicts only the overlapped part 35 of the positive electrode current collector tabs 11, the negative electrode current collector tabs 12 are disposed in a similar manner.) Referring to FIG. 6, the respective widths L13 and L14 of the positive and negative electrode current collector terminals 15 and 16 are both 30 mm, and the distance L15 between the positive and negative electrode current collector terminals 15 and 16 is 32 mm. In FIG. 6, reference numeral 40 denotes plastic parts made of a non-oriented polyolefin material, which cover the positive and negative electrode current collector terminals 15 and 16 that exist at the welding locations of the laminate battery case. Due to the presence of the plastic parts 40, the melt-bonding portions of the laminate film at which the positive and negative electrode current collector terminals 15 and 16 exist can be sealed reliably.

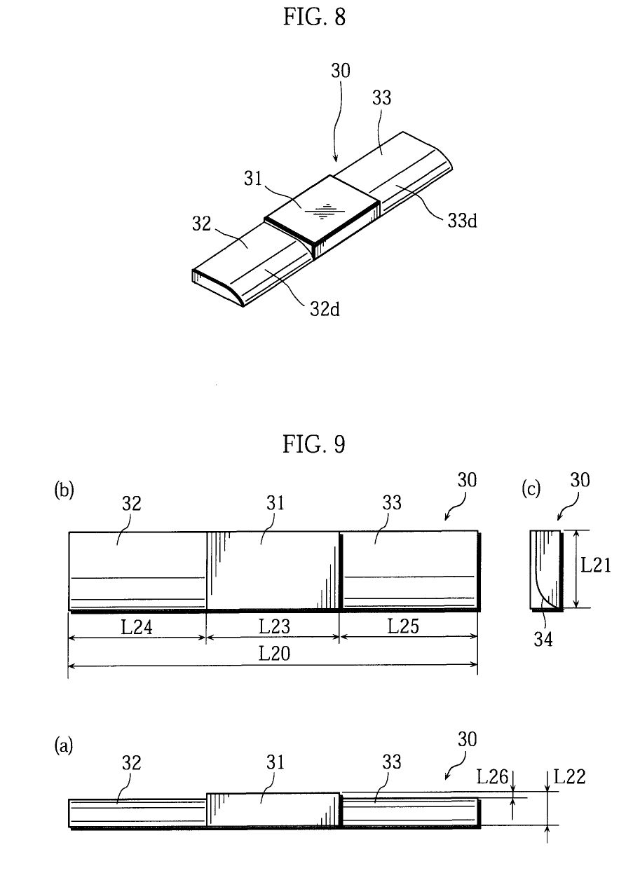

The specific structure of the spacer 30 is as follows. As illustrated in FIG. 8 and FIGS. 9(a) through 9(c), the length L20 of the spacer 30 is 98 mm, the width L21 is 17 mm, and the height L22 is 6 mm. The spacer 30 comprises an inward displacement restricting protrusion 31 (the length L23 is 32 mm), which is provided at the central portion in order to inhibit the positive and negative electrode current collector terminals 15 and 16 from shifting (deforming) inwardly, and current collector tab-contacting portions 32 and 33 (both the lengths L24 and L25 are 33 mm each), which are provided on both sides of the inward displacement restricting protrusion 31. Since the lengths L24 and L25 of the current collector tab-contacting portions 32 and 33 are slightly greater than the widths L3 and L9 (30 mm each) of the positive and negative electrode current collector tabs 11 and 12, the current collector tab-contacting portions 32 and 33 can make contact with the positive and negative electrode current collector tabs 11 and 12 reliably. The current collector tab-contacting portions 32 and 33 have respective curved portions 32d and 33d provided on the stacked electrode assembly 10 side, which prevent a large mechanical stress applied to the positive and negative electrode current collector tabs 11 and 12. A level difference (L26 is 0.5 mm) is provided between the inward displacement restricting protrusion 31 and the current collector tab-contacting portions 32 and 33, so when the two spacers 30 are disposed on both sides of the positive and negative electrode current collector tabs 11 and 12, a welded portion 36 between the positive electrode current collector tabs 11 and the positive electrode current collector terminal 15 can be compressed by the current collector tab-contacting portions 32, and at the same time, a welded portion 36 between the negative electrode current collector tabs 12 and the negative electrode current collector terminal 16 can be compressed between the current collector tab-contacting portions 33.

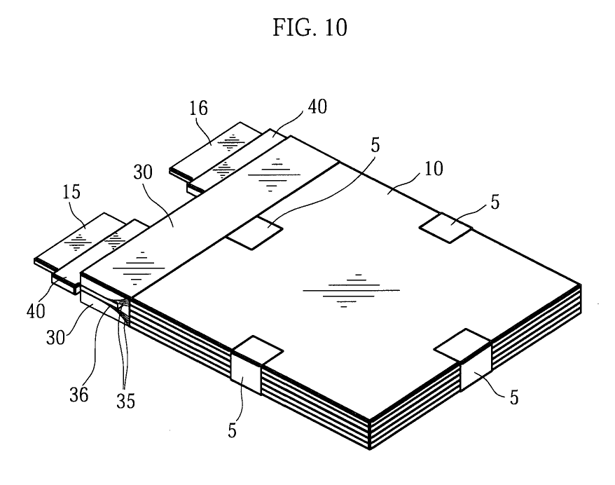

Thus, since the spacers 30 exist in the accommodating space 18, the welded portions 36 between the positive and negative electrode current collector tabs 11, 12 and the positive and negative electrode current collector terminals 15, 16 are compressed, as illustrated in FIG. 10 and so forth. As a result, even when the stacked electrode assembly 10 sways in the laminate battery case 25, for example, it is possible to prevent the positive and negative electrode current collector tabs 11 and 12 from being deformed or disconnected at the welded portions 36 between the positive and negative electrode current collector tabs 11, 12 and the positive and negative electrode current collector terminals 15, 16 or in the vicinities thereof. Moreover, since both the width L23 of the inward displacement restricting protrusion 31 of the spacer 30 and the distance L15 between the positive and negative electrode current collector terminals 15 and 16 are 32 mm, the positive and negative electrode current collector terminals 15 and 16 are prevented from shifting (deforming) inwardly. In addition, the free space inside the battery is minimized because of the presence of the spacers 30. Therefore, displacement of the stacked electrode assembly 10 can be prevented. Furthermore, the spacers 30 and the positive and negative electrode current collector tabs 11 and 12 make contact with each other at regions other than the welded portions 36 between the positive and negative electrode current collector tabs 11, 12 and the positive and negative electrode current collector terminals 15, 16. As a result, the positive and negative electrode current collector tabs 11 and 12 are prevented from being deformed or disconnected also at regions other than the welded portions 36. What is more, the spacers 30 can reserve the electrolyte solution, making it possible to alleviate the problem of the electrolyte amount shortage in the battery, and accordingly, the battery capacity loss and the cycle performance degradation during discharge are lessened.

It should be noted that the depths of the accommodating recessed portions in the two sheets of laminate film 28 (which have not yet been welded together) are 5 mm each, so the sum of the depths is smaller than the thickness L11 (12 mm) of the stacked electrode assembly 10 that has not been yet enclosed in the accommodating space 18 of the laminate battery case 25. With such a construction, a large force is applied to the stacked electrode assembly 10 in the stacking direction when welding the laminate films 28 together to prepare the laminate battery case 25, and therefore, displacement of the stacked electrode assembly 10 can be prevented.

### Fabrication of Prismatic Lithium Ion Battery

### Preparation of Positive Electrode Plate

90 mass % of LiCoO₂ as a positive electrode active material, 5 mass % of carbon black as a conductive agent, and 5 mass % of polyvinylidene fluoride as a binder agent were mixed with an N-methyl-2-pyrrolidone (NMP) solution as a solvent to prepare a positive electrode mixture slurry. Next, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm, and thereafter, it was cut into a sheet with a width L1 and a height L2 and having a positive electrode current collector tab 11 protruding therefrom, to prepare a positive electrode plate 1.

### Preparation of Negative Electrode Plate

95 mass % of natural graphite powder as a negative electrode active material and 5 mass % of polyvinylidene fluoride as a binder agent were mixed with an NMP solution as a solvent to prepare a slurry. Thereafter, the resultant slurry was applied onto both sides of a copper foil (thickness: 10 μm) serving as a negative electrode current collector. Thereafter, the material was dried to remove the solvent and compressed with rollers to a thickness of 0.08 mm, and thereafter, it was cut into a sheet with a width L7 and a height L8 and having a negative electrode current collector tab 12 protruding therefrom, to prepare a negative electrode plate 2.

### Preparation of Battery

51 sheets of the negative electrode plate 2 and 50 sheets of the positive electrode plate 1, each prepared in the above-described manners, were alternately stacked one upon the other with the separators 3 interposed therebetween, to prepare a stacked electrode assembly 10. It should be noted that negative electrode plates 2 were disposed at the opposite endmost portions of the stacking direction of the stacked electrode assembly 10. Next, tapes 5 for preventing misalignment were affixed on four sides of the stacked electrode assembly 10 so as to straddle over the stacked electrode assembly 10.

Next, the 50 sheets of the positive electrode current collector tab 11, which protrude from the stacked electrode assembly 10, were disposed so that 25 sheets thereof were overlapped on each of the observe side and the reverse side of the positive electrode current collector terminal 15. Thereafter, the positive electrode current collector tabs 11 and the positive electrode current collector terminal 15 were welded together by ultrasonic welding. Likewise, the 51 sheets of the negative electrode current collector tab 12, which protrude from the stacked electrode assembly 10, were disposed so that 25 sheets or 26 sheets thereof were overlapped on each of the obverse or reverse side of the negative electrode current collector terminal 16. Thereafter, the negative electrode current collector tabs 12 and the negative electrode current collector terminal 16 were welded by ultrasonic welding. Thereafter, the stacked electrode assembly 10 and the spacers 30 were disposed in the accommodating space 18 of the laminate battery case 25, as illustrated in FIG. 11, so that the spacers 30 sandwich the positive and negative electrode current collector tabs 11, 12 and the positive and negative electrode current collector terminals 15, 16. Thereafter, the laminate films 28 were melt-bonded to each other at one side of the laminate films in which the positive and negative electrode current collector terminals 15 and 16 exist with the positive and negative electrode current collector terminals 15 and 16 protruding from the laminate films 28. Subsequently, the laminate films 28 were melt-bonded at two sides of the remaining three sides of the laminate films 28. Thus, the stacked electrode assembly 10 was placed inside the laminate battery case 25. Lastly, a non-aqueous electrolyte solution was filled into the laminate battery case 25 through the opening of the laminate battery case 25, and thereafter, the opening of the laminate battery case 25 (the remaining one side of the laminate films) was melt-bonded while the internal pressure of the laminate battery case 25 was kept at 30 torr or less, to thus prepare a stack type battery. The above-mentioned non-aqueous electrolyte solution was prepared by dissolving LiPF₆ at a concentration of 1 M (mole/liter) in a mixed solvent of 30:70 volume ratio of ethylene carbonate (EC) and methyl ethyl carbonate (MEC). The internal pressure of the laminate battery case 25 was restricted to be 30 torr or less because, in such a condition, the pressure applied to the spacers 30 and the stacked electrode assembly 10 is so large that the welded portions between the positive and negative electrode current collector terminals 15, 16 and the positive and negative electrode current collector tabs 11, 12 can be pressure-fixed and misalignment in the stacks within the stacked electrode assembly 10 can be prevented.

### Additional Embodiments

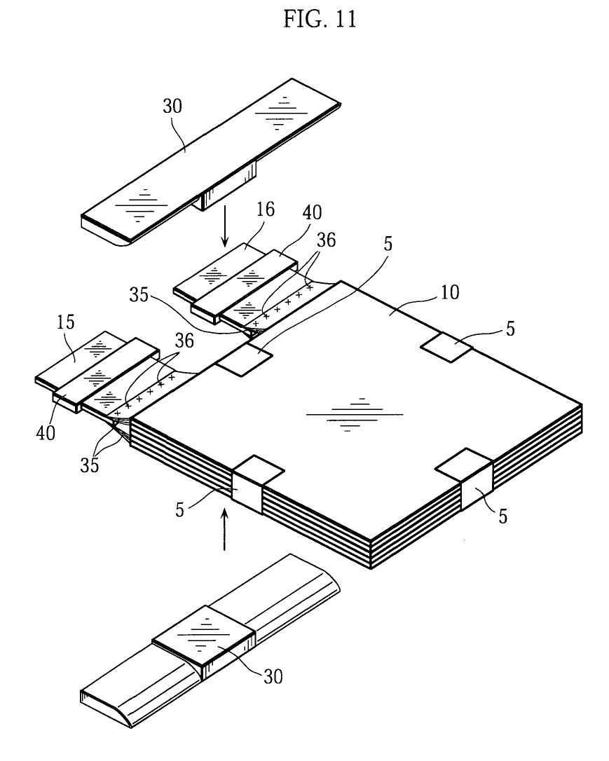

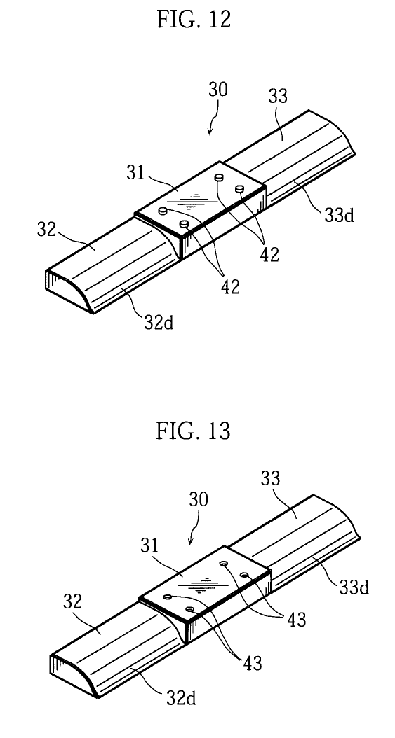

(1) Although the first embodiment has described that the inward displacement restricting protrusion 31 of the spacer 30 has a flat surface shape, this is illustrative only. However, it is also possible that the inward displacement restricting protrusion 31 of one of the spacers 30 may be provided with first positioning protrusions 42, as illustrated in FIG. 12, and at the same time, the inward displacement restricting protrusion 31 of the other one of the spacers 30 may be provided with first positioning holes 43 in which the first positioning protrusions 42 can fit, as illustrated in FIG. 13. This structure facilitates mutual positioning of the two spacers 30 and also prevents misalignment of the spacers 30 after the manufacture of the battery.

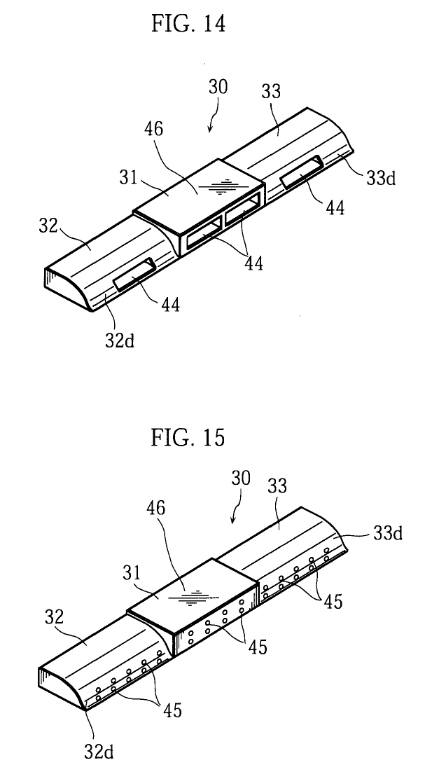

(2) Although the first embodiment has described that the spacer 30 is composed of a porous sintered material made of ceramic and the entire spacer 30 can retain an electrolyte solution, this is illustrative only. The spacer 30 may comprise an outer shell portion 46 and an electrolyte reserving portion (not shown) disposed in the outer shell portion 46, as illustrated in FIGS. 14 and 15. While the outer shell portion 46 has electrolyte resistant property, the electrolyte reserving portion may be made of a material that has electrolyte resistant property and at the same time is capable of reserving an electrolyte solution. In FIGS. 14 and 15, reference numerals 44 and 45 denote electrolyte supply ports that open in a direction toward the stacked electrode assembly 10 and are in communication with the electrolyte reserving portion. Such a structure makes it possible to supply the electrolyte solution reserved in the electrolyte reserving portion to the stacked electrode assembly 10. The electrolyte supply ports 44, 45 are directed toward the stacked electrode assembly 10 so that the electrolyte solution can be supplied to the stacked electrode assembly 10 more smoothly.

(3) Although the first embodiment has described that the spacer 30 has the curved portions 32d and 33d, this is illustrative only. As illustrated in FIG. 16, it is possible that the spacer 30 may not have the curved portions 32d and 33d (it is sufficient that the spacer 30 has at least a structure for compressing the welded portions 36).

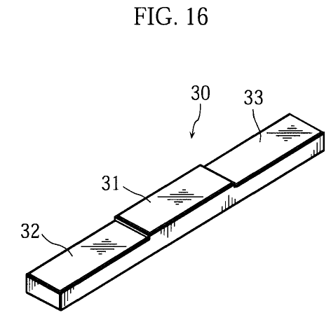

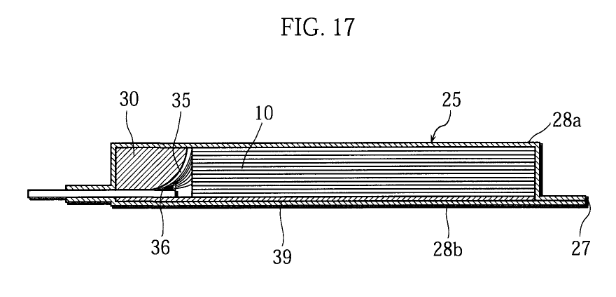

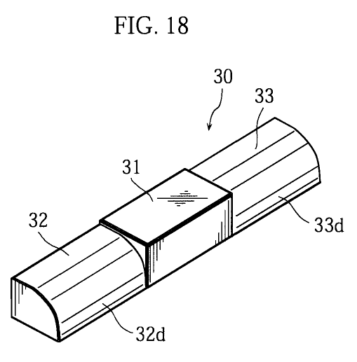

(4) The first embodiment has described that the accommodating recessed portions that form the accommodating space 18 are provided in both of the two laminate films 28, but this is illustrative only. As illustrated in FIG. 17, it is also possible that only one laminate film 28a has an accommodating recessed portion that forms the accommodating space 18, and the other laminate film 28b does not have an accommodating recessed portion that forms the accommodating space 18. In this case, the welded portions 36 between the positive and negative electrode current collector tabs 11, 12 and the positive and negative electrode current collector terminals 15, 16 are formed only on the respective one sides of each of the positive and negative electrode current collector terminals 15 and 16, so only one spacer 30 with a large height is needed, as illustrated in FIG. 18. In FIG. 17, reference numeral 39 denotes a sheet made of plastic.

In addition, it is not always necessary to use two sheets of laminate film 28, and it is also possible to form the laminate battery case 25 by folding over one sheet of laminate film 28.

(5) In the first embodiment, 50 sheets of the positive electrode plate 1 and 51 sheets of the negative electrode plate 2 were used, but the invention is not limited to a battery with such a structure. That said, when the number of stacks of each of the positive electrode plate 1 and the negative electrode plate 2 is 30 or greater, misalignment in the stacks tend to occur easily, and therefore, the present invention is very effective in such a case.

(6) The positive electrode active material is not limited to the LiCoO₂, but it is also possible to use other substances such as LiNiO₂, LiMn₂O₄, and combinations thereof. The negative electrode active materials are not limited to natural graphite as described above, but it is also possible to use other substances such as artificial graphite.

(7) In the first embodiment, the negative electrode active material layer 2a was formed on both sides of the negative electrode conductive current collector of all the negative electrode plates 1. However, it is possible that the negative electrode active material layers may not be provided in the portions that do not face the positive electrode plates (specifically, the negative electrode active material layers may not be provided on the outer sides of the outermost negative electrode plates). Such a configuration allows the stacked electrode assembly 10 to have a smaller thickness, making it possible to achieve a higher capacity density of the battery.

### Second Embodiment

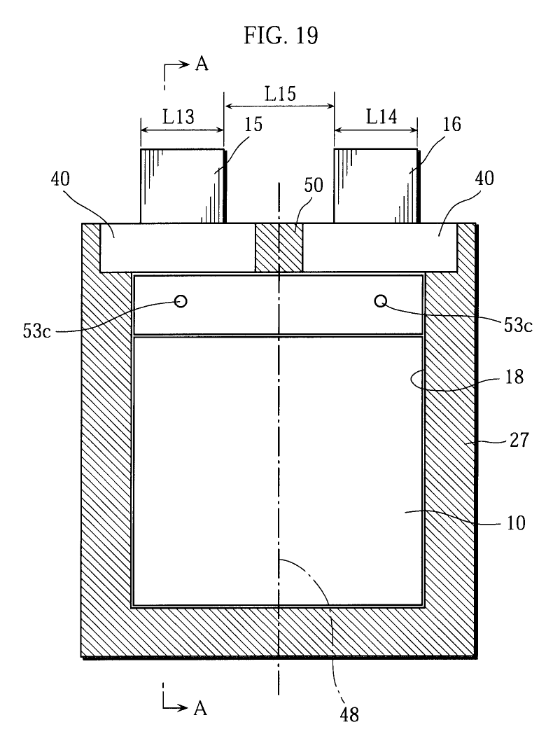

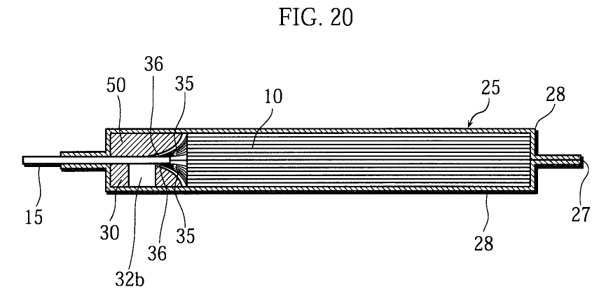

Hereinbelow, a stacked type battery (prismatic lithium ion battery) according to a second embodiment of the present invention will be described with reference to FIGS. 19 through 32. As seen from FIGS. 19 and 20, the second embodiment has a similar configuration to the first embodiment except for the spacers, so the description mainly discusses the spacers. In the first embodiment, the two spacers were denoted by the same reference numeral (30) because the two spacers have substantially the same configuration in the first embodiment in the cases that two spacers are used in a stack type battery. However, in the present embodiment, two spacers are denoted by different reference numerals because the two spacers have significantly different structures (specifically, a spacer 30 and a spacer 50 exist in the second embodiment).

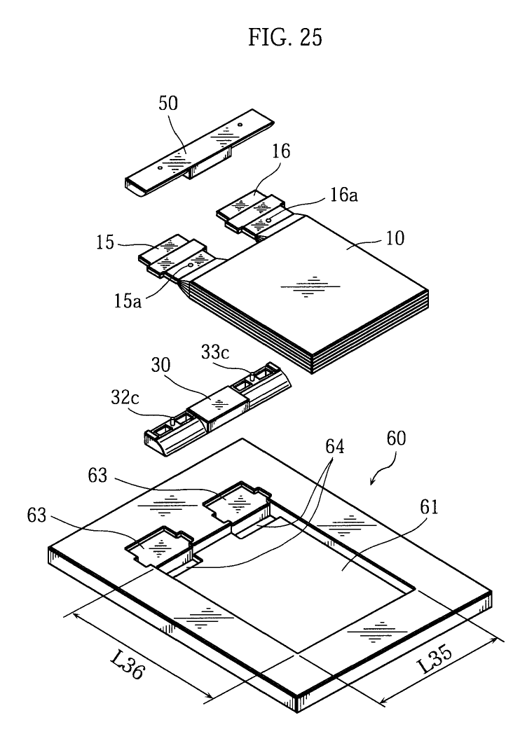

Here, the differences from the first embodiment other than the spacers will be mentioned first. As illustrated in FIG. 25, a second positioning hole 15a, in which a second positioning protrusion 32c of a later-described spacer 30 is to be inserted, is formed in the positive electrode current collector terminal 15, and a second positioning hole 16a, in which a second positioning protrusion 33c of the later-described spacer 30 is to be inserted, is formed in the negative electrode current collector terminal 16. In FIG. 19, both the width L13 of the positive electrode current collector terminal 15 and the width L14 of the negative electrode current collector terminal 15 are 30 mm each, as in the first embodiment.

Next, the spacers 30 and 50 will be described below.

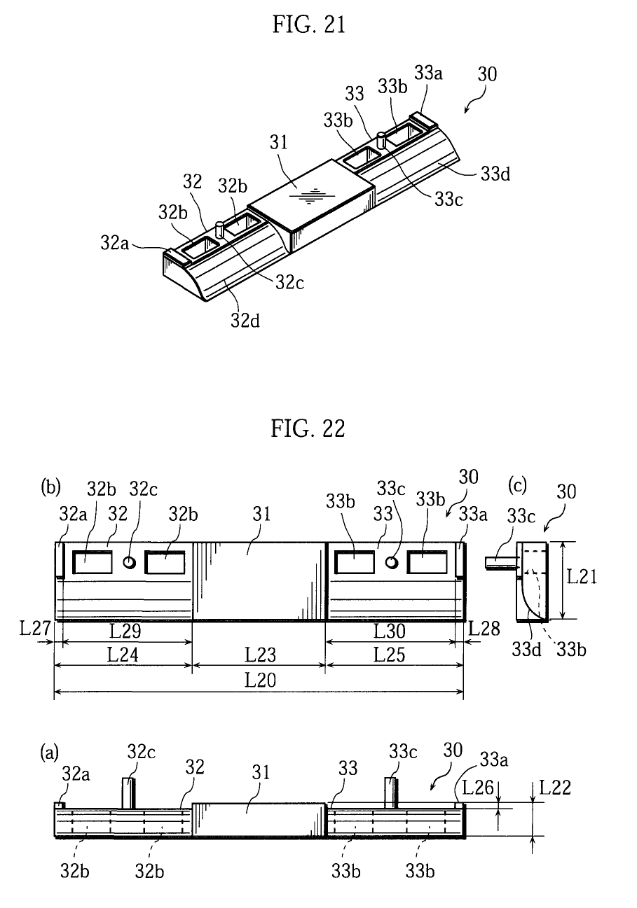

Of the spacers 30 and 50, the spacer 30 has the following specific structure. As illustrated in FIG. 21 and FIGS. 22(a) through 22(c), the length L20 of the spacer 30 is 98 mm, the width L21 is 17 mm, and the height L22 is 6 mm. The spacer 30 comprises an inward displacement restricting protrusion 31, which is provided at the central portion, and current collector tab-contacting portions 32 and 33 (both the lengths L24 and L25 are 33 mm each), which are provided on both sides of the inward displacement restricting protrusion 31. The length L23 of the inward displacement restricting protrusion 31 is 32 mm so that it is substantially the same as the distance between the positive and negative electrode current collector terminals 15 and 16. This prevents the positive and negative electrode current collector terminals 15 and 16 from shifting (deforming) inwardly. In addition, outward displacement restricting protrusions 32a and 33a are formed at end portions of the current collector tab-contacting portions 32 and 33, respectively, which prevents the positive and negative electrode current collector terminals 15 and 16 from shifting outwardly.

In the present embodiment, both the widths L27 and L28 of the outward displacement restricting protrusions 32a and 33a are 3 mm each. Accordingly, both the distance L29 between the inward displacement restricting protrusion 31 and the outward displacement restricting protrusion 32a and the distance L30 between the inward displacement restricting protrusion 31 and the outward displacement restricting protrusion 33a are 30 mm each so as to be the same as the widths L13 and L14 (see FIG. 19) of the positive and negative electrode current collector terminals 15 and 16. This reliably prevents the positive and negative electrode current collector terminals 15 and 16 from shifting inwardly and outwardly. It should be noted that the height of the outward displacement restricting protrusions 32a and 33a is the same as the level difference between the inward displacement restricting protrusion 31 and the current collector tab-contacting portions 32 and 33. Specifically, L26=0.5 mm.

In addition, two sets of two through holes 32b and 33b for ultrasonic welding equipment, in which an anvil of later-described ultrasonic welding equipment (joining equipment) is to be inserted, are formed respectively in the current collector tab-contacting portions 32 and 33. The second positioning protrusion 32c is formed between the two through holes 32b for ultrasonic welding equipment, and the second positioning protrusion 33c is formed between the two through holes 33b for ultrasonic welding equipment. The second positioning protrusion 32c is inserted into the second positioning hole 15a formed in the positive electrode current collector terminal 15, and the second positioning protrusion 33c is inserted into the second positioning hole 16a formed in the negative electrode current collector terminal 16, whereby the positioning between the spacer 30 (the stacked electrode assembly 10) and the positive and negative electrode current collector terminals 15 and 16 can be made accurately. The current collector tab-contacting portions 32 and 33 have respective curved portions 32d and 33d provided on the stacked electrode assembly 10 side, which prevent a large mechanical stress applied to the positive and negative electrode current collector tabs 11 and 12.

On the other hand, as illustrated in FIG. 23, the spacer 50 has the same structure and the same dimensions as the spacer 30, in the respect that it comprises an inward displacement restricting protrusion 51 and current collector tab-contacting portions 52 and 53 provided on both sides of the inward displacement restricting protrusion 51, and that outward displacement restricting protrusions 52a and 53a are formed at respective end portions of the current collector tab-contacting portions 52 and 53. The differences are that the through holes 32b and 33b for ultrasonic welding equipment are not formed in the spacer 30, and that third positioning through holes 52c and 53c (which are formed at the locations corresponding to the second positioning protrusion 32c and 33c, respectively, and have the same effects as the first positioning hole 43 shown in the first embodiment above) are formed therein in place of the second positioning protrusions 32c and 33c.

It should be noted that the depths of the accommodating recessed portions in the two sheets of laminate film 28 (which have not yet been welded together) are 5 mm each, so the sum of the depths is smaller than the thickness L11 (12 mm) of the stacked electrode assembly 10 that has not been yet enclosed in the accommodating space 18 of the laminate battery case 25. With such a construction, a large force is applied to the stacked electrode assembly 10 in the stacking direction when welding the laminate films 28 together to prepare the laminate battery case 25, and therefore, displacement of the stacked electrode assembly 10 can be prevented.

A stacked electrode assembly manufacturing jig used for manufacturing the above-described battery will be described below.

As illustrated in FIG. 25, the stacked electrode assembly manufacturing jig 60 has a first recessed portion 61, which has substantially the same shape as the stacked electrode assembly 10 provided with the spacer 30, and second recessed portions 62 and 63, which have substantially the same shapes as the positive electrode current collector terminal 15 and the negative electrode current collector terminal 16, respectively, and are shallower than the first recessed portion 61. Specific dimensions of the first recessed portion 61 are as follows. The width L35 is substantially the same dimension (about 100 mm) as the width of the stacked electrode assembly 10 (which is the same as the width L6 of the separator 3 and the width L7 of the negative electrode 2). The height L36 is substantially the same dimension (about 117 mm) as the total of the height of the stacked electrode assembly 10 (which is the same as the height L5 of the separator 3 and the height L8 of the negative electrode 2) and the width L21 of the spacer 30. In the stacked electrode assembly manufacturing jig 60, through holes 64 for ultrasonic welding equipment, through which an anvil of ultrasonic welding equipment (joining equipment) is inserted, are formed at the locations that correspond to the welding position between the positive electrode current collector tabs 11 and the positive electrode current collector terminal 15 and the welding position between the negative electrode current collector tabs 12 and the negative electrode current collector terminal 16.

As described above, forming the first recessed portion 61, which has substantially the same shape as the stacked electrode assembly 10 with the spacer 30, enables to determine the relative position between the stacked electrode assembly 10 and the spacer 30 and accordingly determine the relative position between the spacer 30 and the positive and negative electrode current collector tabs 11 and 12, which respectively extend outwardly from the positive and negative electrode plates 1 and 2, which are parts of the stacked electrode assembly 10. In addition, forming the two second recessed portions 62 and 63, which have substantially the same shapes as the positive electrode current collector terminal 15 and the negative electrode current collector terminal 16, respectively, enables to determine the relative position between the spacer 30 and the positive and negative electrode current collector terminals 15 and 16 as well as the relative position between the positive and negative electrode current collector terminals 15 and 16 and the positive and negative electrode current collector tabs 11 and 12. This serves to suppress variations among batteries in the locations at the laminate battery case 25 from which the positive and negative electrode current collector terminals 15 and 16 protrude and in the distance between the positive and negative electrode current collector terminals 15 and 16. Therefore, when a battery module is made using a multiplicity of batteries, electrical connection can be made smoothly between the current collector terminals. As a result, the reliability and productivity of the battery module can be prevented from degrading.

Fabrication of Prismatic Lithium Ion Battery

The pouch-type separator, the negative electrode plate, and the stacked electrode assembly 10 can be fabricated in the same manners as described in the first embodiment. Therefore, the description thereof will be omitted.

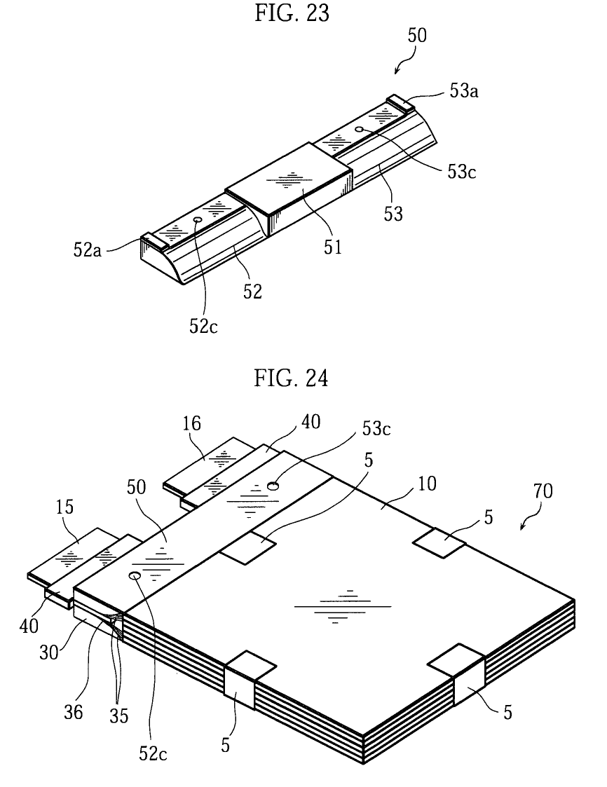

First, as illustrated in FIGS. 25 and 26, the spacer 30 and the stacked electrode assembly 10, on which tapes 5 for preventing misalignment are affixed in four sides, are placed in the first recessed portion 61 of the stacked electrode assembly manufacturing jig 60. Also, the positive electrode current collector terminal 15 and the negative electrode current collector terminal 16 are placed respectively in the second recessed portions 62 and 63 while the second positioning protrusions 32c and 33c are being inserted respectively into the second positioning holes 15a and 16a. At this time, 25 sheets of the positive electrode current collector tab 11 are overlapped on each of the observe and reverse sides of the positive electrode current collector terminal 15, while 25 sheets or 26 sheets of the negative electrode current collector tab 12 are overlapped on each of the observe and reverse sides of the negative electrode current collector terminal 16. Thereafter, an anvil of ultrasonic welding equipment (joining equipment) is inserted into the stacked electrode assembly manufacturing jig 60's through holes 64 for ultrasonic welding equipment and the spacer 30's through holes 32b and 33b for ultrasonic welding equipment. Then, the positive and negative electrode current collector tabs 11 and 12 are ultrasonic welded to respective one sides of the positive and negative electrode current collector terminals 15 and 16 while the positive electrode current collector tabs 11 are being pressed against the positive electrode current collector terminal 15 and the negative electrode current collector tabs 12 are being pressed against the negative electrode current collector terminal 16. Thereafter, the positive and negative electrode current collector tabs 11 and 12 are ultrasonic welded to the respective other sides of the positive and negative electrode current collector terminals 15 and 16. Further, an adhesive agent is applied onto the upper surfaces of the displacement restricting protrusion 31 and the outward displacement restricting protrusions 32a and 33a, and subsequently, the second positioning protrusions 32c and 33c are inserted into the third positioning through holes 52c and 53c, respectively, to join the spacer 30 and the spacer 50 as illustrated in FIG. 24. Thus, a stacked electrode assembly 70 is prepared.

Thereafter, the laminate films 28 were melt-bonded to each other at one side of the laminate films in which the positive and negative electrode current collector terminals 15 and 16 exist, with the positive and negative electrode current collector terminals 15 and 16 protruding from the laminate films 28. Subsequently, the laminate films 28 were melt-bonded at two sides of the remaining three sides of the laminate films 28, whereby the stacked electrode assembly 70 was placed inside the laminate battery case 25. Lastly, a non-aqueous electrolyte solution was filled into the laminate battery case 25 through the opening of the laminate battery case 25, and thereafter, the opening of the laminate battery case 25 (the remaining one side of the laminate films) was melt-bonded while the internal pressure of the laminate battery case 25 was kept at 30 torr or less, to thus prepare a stack type battery. The above-mentioned non-aqueous electrolyte solution was prepared by dissolving LiPF₆ at a concentration of 1 M (mole/liter) in a mixed solvent of 30:70 volume ratio of ethylene carbonate (EC) and methyl ethyl carbonate (MEC).

### Additional Embodiments

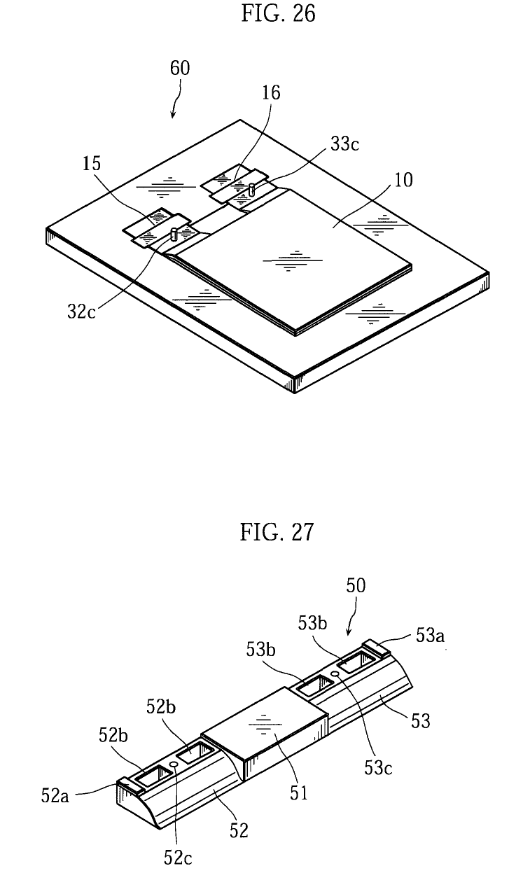

(1) Although the ultrasonic welding equipment through holes are not provided in the spacer 50 in the second embodiment, ultrasonic welding equipment through holes 52b and 53b may be provided therein as illustrated in FIG. 27. Such a structure has an advantageous effect that the positive and negative electrode current collector tabs 11 and 12 can be ultrasonic welded to both sides of the positive and negative electrode current collector terminals 15 and 16, respectively, at one time.

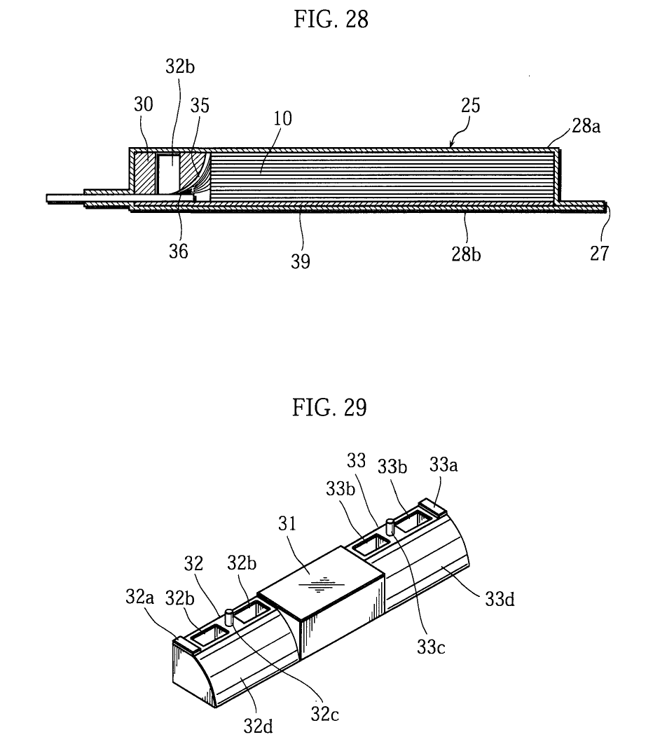

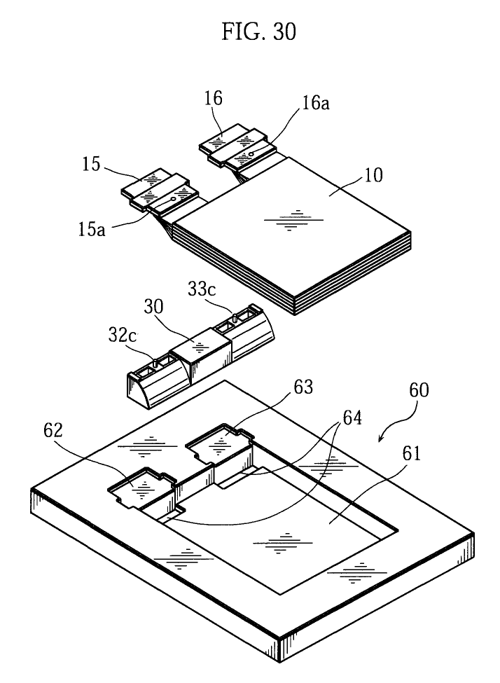

(2) The second embodiment has described that the accommodating recessed portions that form the accommodating space are provided in both of the two laminate films 28, but this is illustrative only. As illustrated in FIG. 28, it is also possible that only one laminate film 28a has an accommodating recessed portion that forms the accommodating space, and the other laminate film 28b does not have an accommodating recessed portion that forms the accommodating space. In this case, the welded portions between the positive and negative electrode current collector tabs 11, 12 and the positive and negative electrode current collector terminals 15, 16 are formed only on respective one sides of the positive and negative electrode current collector terminals 15 and 16, so only one spacer 30 with a large height is needed, as illustrated in FIG. 29. It is desirable that the stacked electrode assembly manufacturing jig 60 used in this case should have a first recessed portion 61 that has a deep bottomed shape (which has substantially the same dimension as the thickness of the stacked electrode assembly 10), as illustrated in FIG. 30. In FIG. 28, reference numeral 39 denotes a sheet made of plastic.

In addition, it is not always necessary to use two sheets of laminate film 28, and it is also possible to form the laminate battery case 25 by folding over one sheet of laminate film 28.

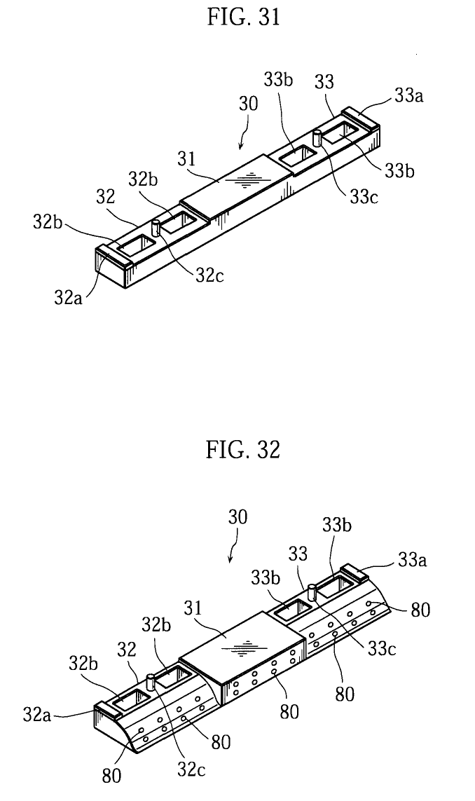

(3) Although the second embodiment has described that the spacer 30 has the curved portions 32d and 33d, this is illustrative only. As illustrated in FIG. 31, it is possible that the spacer 30 may not have the curved portions 32d and 33d.

(4) As illustrated in FIG. 32, forming electrolyte reserve holes 80 that open in a direction toward the stacked electrode assembly 10 in the spacer 30 makes it possible to supply the electrolyte solution reserved in the electrolyte reserve holes 80 to the stacked electrode assembly 10. As a result, the problem of the electrolyte amount shortage in the battery is alleviated, and accordingly, the battery capacity loss and the cycle performance degradation during discharge are lessened even when the battery is charged and discharged at high rates.

(5) Although the second embodiment has described that the spacer 30 and the spacer 50 are fixed by an adhesive agent, this is illustrative only. It is also possible to fix the spacer 30 and the spacer 50 each other by fitting the second positioning protrusions 32c and 33c of the spacer 30 into the third positioning through holes 52c and 53c of the spacer 50.

(6) The positive electrode active material is not limited to the LiCoO₂, but it is also possible to use other substances such as LiNiO₂, LiMn₂O₄, and combinations thereof. The negative electrode active materials are not limited to natural graphite as described above, but it is also possible to use other substances such as artificial graphite and Si.

(7) In the second embodiment, the negative electrode active material layer 2a was formed on both sides of the negative electrode conductive current collector of all the negative electrode plates 2. However, it is possible that the negative electrode active material layers may not be provided in the portions that do not face the positive electrode plates (specifically, the negative electrode active material layers may not be provided on the outer sides of the outermost negative electrode plates). Such a configuration allows the stacked electrode assembly 10 to have a smaller thickness, making it possible to achieve a higher capacity density of the battery.

The present invention may be applied to, for example, batteries used for such equipment as robots, electric vehicles, and backup power sources.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A stack type battery comprising:
a stacked electrode assembly comprising a plurality of positive electrode plates having respective positive electrode current collector tabs extending outwardly therefrom, a plurality of negative electrode plates having respective negative electrode current collector tabs extending outwardly therefrom, and separators, the positive electrode plates and the negative electrode plates being alternately stacked one upon the other with the separators interposed therebetween;
a square-shaped laminate battery case, for enclosing the stacked electrode assembly and an electrolyte solution in an accommodating space therein, being formed by welding peripheral edges of one or more laminate films each comprising a metal layer and a plastic layer;
a positive electrode current collector terminal joined to the positive electrode current collector tabs being overlapped with each other and a negative electrode current collector terminal joined to the negative electrode current collector tabs being overlapped with each other, the positive and negative electrode current collector terminals protruding from one side of the laminate battery case in a separated manner with respect to its center line; and
at least one insulative spacer, for compressing respective joined portions between the positive and negative electrode current collector tabs and the positive and negative electrode current collector terminals, the at least one insulative spacer being disposed in a tab-connecting space, the tab-connecting space being between an inner face of the laminate battery case through which the positive and negative electrode current collector terminals protrude and a face of the stacked electrode assembly from which the positive and negative electrode current collector tabs protrude, and having an inward displacement restricting protrusion, for restricting inward displacement of the positive and negative electrode current collector terminals, being provided at a location of the spacer corresponding to a region between the positive and negative electrode current collector terminals.

2. The stack type battery according to claim 1, wherein the spacer has a shape such that it fills up the tab-connecting space excluding a region in which the positive and negative electrode current collector tabs are overlapped.

3. The stack type battery according to claim 1, wherein the spacer is made of a material that is resistant to the electrolyte solution and is capable of reserving the electrolyte solution.

4. The stack type battery according to claim 1, wherein the spacer has an outer shell portion and an electrolyte reserving portion disposed in the outer shell portion, the outer shell portion being made of a material that is resistant to the electrolyte solution while the electrolyte reserving portion being made of a material that is resistant to the electrolyte solution and is capable of reserving the electrolyte solution, and the outer shell portion having an electrolyte supply port for supplying the electrolyte solution reserved in the electrolyte reserving portion to the stacked electrode assembly.

5. The stack type battery according to claim 4, wherein the electrolyte supply port is provided in a direction toward the stacked electrode assembly.

6. The stack type battery according to claim 1, wherein: the one or more laminate films comprise two laminate films, each of the laminate films having an accommodating recessed portion that constitutes the accommodating space; the positive electrode current collector tabs and the positive electrode current collector terminal are joined to each other with the positive electrode current collector tabs being overlapped on both sides of the positive electrode current collector terminal while the negative electrode current collector tabs and the negative electrode current collector terminal are joined to each other with the negative electrode current collector tabs being overlapped on both sides of the negative electrode current collector terminal; and the at least one insulative spacer comprises two insulative spacers disposed in respective tab-connecting spaces existing between the laminate battery case and the positive and negative electrode current collector tabs.

7. The stack type battery according to claim 6, wherein one of the spacers has a first positioning protrusion and the other one of the spacers has a first positioning hole.

8. The stack type battery according to claim 1, wherein the one or more laminate films comprise two laminate films, only one of the laminate films having an accommodating recessed portion that constitutes the accommodating space; the positive electrode current collector tabs and the positive electrode current collector terminal are joined to each other with the positive electrode current collector tabs being overlapped on only one side of the positive electrode current collector terminal while the negative electrode current collector tabs and the negative electrode current collector terminal are joined to each other with the negative electrode current collector tabs being overlapped on only one side of the negative electrode current collector terminal; and the spacer is disposed only in the tab-connecting space existing between the laminate battery case and the positive and negative electrode current collector tabs.

9. The stack type battery according to claim 1, wherein the stacked electrode assembly has a thickness of 5 mm or greater with respect to its stacking direction.

10. The stack type battery according to claim 1, wherein a positive electrode active material of the positive electrode plates and a negative electrode active material of the negative electrode plates comprise a material capable of intercalating and deintercalating lithium.

11. The stack type battery according to claim 1, wherein: the spacer has substantially the same length as the dimension of the width of the stacked electrode assembly; both ends of the spacer exist at substantially the same locations as both side faces of the stacked electrode assembly; the positive and negative electrode current collector terminals have second positioning holes respectively formed therein; and the spacer has second positioning protrusions at locations corresponding to the second positioning holes.

12. The stack type battery according to claim 11, wherein the spacer has an outward displacement restricting protrusion, for restricting outward displacement of the positive and negative electrode current collector terminals, being provided at a further outward position than a contact position of the spacer and the positive and negative electrode current collector terminals.

13. The stack type battery according to claim 11, wherein: the positive electrode current collector tabs and the positive electrode current collector terminal are joined to each other with the positive electrode current collector tabs being overlapped on both sides of the positive electrode current collector terminal while the negative electrode current collector tabs and the negative electrode current collector terminal are joined to each other with the negative electrode current collector tabs being overlapped on both sides of the negative electrode current collector terminal; the at least one insulative spacer comprises two insulative spacers disposed in respective tab-connecting spaces existing between the laminate battery case and the positive and negative electrode current collector tabs; one of the spacers has the second positioning protrusion, and the other one of the spacers has a third positioning hole in which the second positioning protrusion fits.

14. The stack type battery according to claim 11, wherein the positive electrode current collector tabs and the positive electrode current collector terminal are joined to each other with the positive electrode current collector tabs being overlapped on only one side of the positive electrode current collector terminal while the negative electrode current collector tabs and the negative electrode current collector terminal are joined to each other with the negative electrode current collector tabs being overlapped on only one side of the negative electrode current collector terminal; and the spacer is disposed only in the tab-connecting space existing between the laminate battery case and the positive and negative electrode current collector tabs.

15. A stack type battery comprising:
a stacked electrode assembly comprising a plurality of positive electrode plates having respective positive electrode current collector tabs extending outwardly therefrom, a plurality of negative electrode plates having respective negative electrode current collector tabs extending outwardly therefrom, and separators, the positive electrode plates and the negative electrode plates being alternately stacked one upon the other with the separators interposed therebetween;
a square-shaped laminate battery case, for enclosing the stacked electrode assembly and an electrolyte solution in an accommodating space therein, being formed by welding peripheral edges of one or more laminate films each comprising a metal layer and a plastic layer;
a positive electrode current collector terminal joined to the positive electrode current collector tabs being overlapped with each other and a negative electrode current collector terminal joined to the negative electrode current collector tabs being overlapped with each other, the positive and negative electrode current collector terminals protruding from one side of the laminate battery case in a separated manner with respect to its center line; and
at least one insulative spacer being disposed in a tab-connecting space, the tab-connecting space being between an inner face of the laminate battery case through which the positive and negative electrode current collector terminals protrude and a face of the stacked electrode assembly from which the positive and negative electrode current collector tabs protrude, the at least one insulative spacer having substantially the same length as the dimension of the width of the stacked electrode assembly and both ends of the spacer existing at substantially the same locations as both side faces of the stacked electrode assembly; and
the positive and negative electrode current collector terminals having second positioning holes respectively formed therein; and the spacer having second positioning protrusions at locations corresponding to the second positioning holes.

16. The stack type battery according to claim 15, wherein the spacer has an inward displacement restricting protrusion, for restricting inward displacement of the positive and negative electrode current collector terminals, being provided at a location corresponding to a region between the positive and negative electrode current collector terminals.

17. The stack type battery according to claim 15, wherein the spacer has an outward displacement restricting protrusion, for restricting outward displacement of the positive and negative electrode current collector terminals, being provided at a further outward position than a contact position of the spacer and the positive and negative electrode current collector terminals.

18. The stack type battery according to claim 15, wherein: the positive electrode current collector tabs and the positive electrode current collector terminal are joined to each other with the positive electrode current collector tabs being overlapped on both sides of the positive electrode current collector terminal while the negative electrode current collector tabs and the negative electrode current collector terminal are joined to each other with the negative electrode current collector tabs being overlapped on both sides of the negative electrode current collector terminal; the at least one insulative spacer comprises two insulative spacers disposed in respective tab-connecting spaces existing between the laminate battery case and the positive and negative electrode current collector tabs; one of the spacers has the second positioning protrusion, and the other one of the spacers has a second positioning hole in which the second positioning protrusion fits.

19. The stack type battery according to claim 15, wherein the positive electrode current collector tabs and the positive electrode current collector terminal are joined to each other with the positive electrode current collector tabs being overlapped on only one side of the positive electrode current collector terminal while the negative electrode current collector tabs and the negative electrode current collector terminal are joined to each other with the negative electrode current collector tabs being overlapped on only one side of the negative electrode current collector terminal; and the spacer is disposed only in the tab-connecting space existing between the laminate battery case and the positive and negative electrode current collector tabs.
